(19) United States
(12) Patent Application Publication
(10) Pub. No.: US 2012/0321253 A1
(43) Pub. Date: Dec. 20, 2012

(54) METHOD OF CONNECTING OPTICAL FIBER AND CONNECTING STRUCTURE OF OPTICAL FIBER

(75) Inventors: Osamu SHIMAKAWA, Yokohama-shi (JP); Tomohiko KANIE, Yokohama-shi (JP); Akira INOUE, Yokohama-shi (JP); Hiroo KANAMORI, Yokohama-shi (JP)

(73) Assignee: SUMITOMO ELECTRIC INDUSTRIES, LTD., Osaka-shi (JP)

(21) Appl. No.: 13/480,966

(22) Filed: May 25, 2012

(30) Foreign Application Priority Data
Jun. 17, 2011 (JP) 2011-135212

(51) Int. Cl. G02B 6/38; B23P 11/00

(52) U.S. Cl. 385/71; 29/525.02

(57) ABSTRACT

An optical fiber connecting method and optical fiber connecting structure which can efficiently connect a multicore fiber to a plurality of single-core fibers with high accuracy. The method comprises preparing an MT ferrule for holding an MCF, axially rotating and positioning the MCF with respect to the MT ferrule, and then fixing the MCF to the MT ferrule; preparing an MT ferrule for holding a plurality of SCFs, positioning them such that cores are arranged at respective positions corresponding to arrangements of a plurality of cores in the MCF, and then fixing the plurality of SCFs to the MT ferrule; and positioning and joining the MT ferrules such that the plurality of cores face the respective single cores, so as to connect the MCF to the plurality of SCFs.

### BACKGROUND OF THE INVENTION

1. Field of the Invention

The present invention relates to an optical fiber connecting method for optically connecting a multicore fiber to a single-core fiber and an optical fiber connecting structure.

2. Related Background Art

Techniques for optically connecting a multicore fiber, which comprises a plurality of cores each extending along a predetermined axis and a cladding integrally surrounding the plurality of cores, to a single-core fiber, which comprises a core extending along a predetermined axis and a cladding surrounding the core, have been known (see, for example, Japanese Patent Application Laid-Open No. 57-210313).

For connecting a multicore fiber, which has recently been made with a very fine diameter and ultrahigh density, to a plurality of single-core fibers, it is necessary to connect a plurality of cores at their correct positions between the multicore fiber and the plurality of single-core fibers. When sufficient accuracy cannot be attained in positioning in connected parts at the time of connecting cores to each other, their loss may increase, thereby lowering efficiency.

For solving the problem mentioned above, it is an object of the present invention to provide an optical fiber connecting method and optical fiber connecting structure which can efficiently connect a multicore fiber to a plurality of single-core fibers.

### SUMMARY OF THE INVENTION

For solving the above-mentioned problem, the optical fiber connecting method in accordance with the present invention is an optical fiber connecting method for connecting a multicore fiber, constituted by a plurality of cores and a cladding integrally surrounding the plurality of cores, to a single-core fiber constituted by a single core and a cladding surrounding the core; the method comprising a first step of preparing a first connection member for holding the multicore fiber, positioning the multicore fiber in the first connection member, and then fixing the multicore fiber to the first connection member; a second step of preparing a second connection member for holding a plurality of single-core fibers, positioning the single-core fibers such that the single cores are arranged at respective positions corresponding to arrangements of the plurality of cores in the multicore fiber, and then fixing the plurality of single-core fibers to the second connection member; and a third step of positioning and joining the first and second connection members such that the plurality of cores face the respective single cores, so as to connect the multicore fiber to the plurality of single-core fibers.

This optical fiber connecting method connects a multicore fiber to a plurality of single-core fibers by using first and second connection members. The multicore fiber is fixed to the first connection member after being positioned therein. The plurality of single-core fibers are positioned such that the cores are arranged at respective positions corresponding to arrangements of cores in the multicore fiber and then fixed to the second connection member. Thereafter, the first and second connection members are joined to each other, so as to connect the multicore fiber to a plurality of single-core fibers. Since the multicore fiber and single-core fibers are thus connected to each other after being positioned individually, the cores can be butted against each other with high accuracy, whereby the loss can be reduced. As a result, a multicore fiber can efficiently be connected to a plurality of single-core fibers.

The multicore fiber may have the plurality of cores arranged at equally-spaced intervals in a cross-section thereof, while the single core fiber may be configured such that at least a leading end part of the cladding has an outer diameter equal to an interval between the plurality of cores.

The first connection member has a fiber insertion hole for inserting the multicore fiber and a guide hole for inserting a guide pin, the second connection member has a positioning part for defining the arrangements of the single-core fibers so as to place the single cores in the single-core fibers at positions corresponding to the arrangements of the plurality of cores in the multicore fiber and a guide part for inserting the guide pin, and the guide pin joins the first and second connection members to each other in the third step. This mode allows the guide pin to position the first and second connection members accurately.

The plurality of cores are arranged axially symmetrically at equally-spaced intervals, the first connection member is provided with at least two guide holes, the two guide holes being arranged such that the fiber insertion hole is located therebetween, and the first step axially rotates and positions the multicore fiber with respect to the first connection member such that the arrangements of the plurality of cores form a predetermined angle with a line connecting respective center axes of the two guide holes. This mode can favorably position the multicore fiber.

The second connection member is provided with at least two guide parts, the two guide parts being arranged such that the positioning part is located therebetween, and the second step arranges the single-core fibers at the positioning part, so as to position the plurality of single-core fibers. This mode can favorably achieve a two-dimensional array of the single-core fibers.

The second connection member comprises a first part formed with the positioning part and guide part and a second part for holding the plurality of single-core fibers with the first part. The second connection member comprises a first part formed with a first positioning part constituting the positioning part and a first guide part constituting the two guide parts and a second part formed with a second positioning part constituting the positioning part while being arranged so as to oppose the first positioning part and a second guide part constituting the two guide parts while being arranged so as to oppose the first guide part, and the single-core fiber is held by the first and second parts.

The positioning part has a substantially V-shaped cross-section. Alternatively, the positioning part has a cross-section exhibiting a form corresponding to an outer form of a bundle of the plurality of single-core fibers. Such a mode can position the single-core fibers easily and appropriately.

The first connection member comprises a cylindrical ferrule having a fiber insertion hole for inserting the multicore fiber and an accommodation member for accommodating the ferrule, and the first step axially rotates and positions the multicore fiber such that the arrangements of the plurality of cores form a predetermined angle with a line connecting a predetermined position of the accommodation member and a center axis of the fiber insertion hole. This mode can favorably position the multicore fiber.

The plurality of cores are arranged axially symmetrically at equally-spaced intervals, the accommodation member is provided with a projection projecting radially out of the ferrule, and the first step axially rotates and positions the multicore fiber such that the arrangements of the plurality of cores form a predetermined angle with a line connecting the projection and the center axis of the fiber insertion hole. This mode can favorably position the multicore fiber.

The second connection member has a positioning part for defining the arrangements of the single-core fibers so as to place the single cores in the single-core fibers at positions corresponding to the arrangements of the plurality of cores in the multicore fiber, and the second step arranges the single-core fibers at the positioning part, so as to position the plurality of single-core fibers. This mode can favorably achieve a two-dimensional array of the single-core fibers.

The positioning part has a substantially V-shaped cross-section. Alternatively, the positioning part has a cross-section exhibiting a form corresponding to an outer form of a bundle of the plurality of single-core fibers. Such a mode can position the single-core fibers easily and appropriately.

The second connection member comprises a cylindrical ferrule including a fiber insertion hole, having an inner diameter substantially equal to an outer size of the plurality of single-core fibers, for inserting the plurality of single-core fibers, and the second step inserts and positions the plurality of single-core fibers in the fiber insertion hole. This mode can favorably achieve a two-dimensional array of the single-core fibers.

The fiber insertion hole of the ferrule has a greater bore on one end side for inserting the plurality of single-core fibers therefrom than on the other end side. Such a mode can insert a plurality of optical fibers into the fiber insertion hole easily and appropriately.

The optical fiber connecting structure in accordance with the present invention is an optical fiber connecting structure connecting a multicore fiber, constituted by a plurality of cores and a cladding integrally surrounding the plurality of cores, to a single-core fiber constituted by a single core and a cladding surrounding the core; the optical fiber connecting structure comprising a first connection member for holding the multicore fiber and a second connection member for holding a plurality of single-core fibers, the first connection member positioning and fixing the multicore fiber, the second connection member arranging the single cores at respective positions corresponding to the arrangements of the plurality of cores in the multicore fiber and fixing the plurality of single-core fibers, the first and second connection members being positioned and joined to each other such that the plurality of cores face the respective single cores.

The multicore fiber may have a plurality of cores arranged at equally-spaced intervals in a cross-section thereof, while the single core fiber may be configured such that at least a leading end part of the cladding has an outer diameter equal to an interval between the plurality of cores.

The first connection member has a fiber insertion hole for inserting the multicore fiber and a guide hole for inserting a guide pin, the second connection member has a positioning part for defining the arrangements of the single-core fibers so as to place the single cores in the single-core fibers at positions corresponding to the arrangements of the plurality of cores in the multicore fiber and a guide part for inserting the guide pin, and the guide pin joins the first and second connection members to each other.

The second connection member comprises a first part formed with the positioning part and guide part and a second part for holding the plurality of core fibers with the first part.

The second connection member comprises a first part formed with a first positioning part constituting the positioning part and a first guide part constituting the two guide parts and a second part formed with a second positioning part constituting the positioning part while being arranged so as to oppose the first positioning part and a second guide part constituting two guide parts while being arranged so as to oppose the first guide part, and the single-core fiber is held by the first and second parts.

The positioning part has a substantially V-shaped cross-section. Alternatively, the positioning part has a cross-section exhibiting a form corresponding to an outer form of a bundle of the plurality of single-core fibers.

The first connection member comprises a cylindrical ferrule having a fiber insertion hole for inserting the multicore fiber and an accommodation member for accommodating the ferrule.

The second connection member has a positioning part for defining the arrangements of the single-core fibers so as to place the single cores in the single-core fibers at positions corresponding to the arrangements of the plurality of cores in the multicore fiber.

The positioning part has a substantially V-shaped cross-section. Alternatively, the positioning part has a cross-section exhibiting a form corresponding to an outer form of a bundle of the plurality of single-core fibers.

The second connection member comprises a cylindrical ferrule including a fiber insertion hole, having an inner diameter substantially equal to an outer size of the plurality of single-core fibers, for inserting the plurality of single-core fibers.

The fiber insertion hole of the ferrule has a greater bore on one end side for inserting the plurality of single-core fibers therefrom than on the other end side.

The present invention can connect a multicore fiber to a plurality of single-core fibers efficiently with high accuracy.

### BRIEF DESCRIPTION OF THE DRAWINGS

FIG. 1 is a perspective view illustrating a multicore fiber and single-core fibers connected together by the optical fiber connecting method in accordance with a first embodiment;

FIG. 2 is a view of an MT ferrule as seen from the front side;

FIG. 3 is a view of an MT ferrule as seen from the front side;

FIG. 4 is a view for explaining the structure of an SCF positioning groove;

FIG. 5 is a view for explaining a method of positioning an MCF;

FIG. 6 is a view illustrating other modes of the MT ferrule;

FIG. 7 is a view illustrating other modes of the MT ferrule;

FIG. 8 is a view illustrating other modes of the MT ferrule;

FIG. 9 is a view illustrating other modes of the MT ferrule;

FIG. 10 is a perspective view for explaining a method of assembling the MT ferrule;

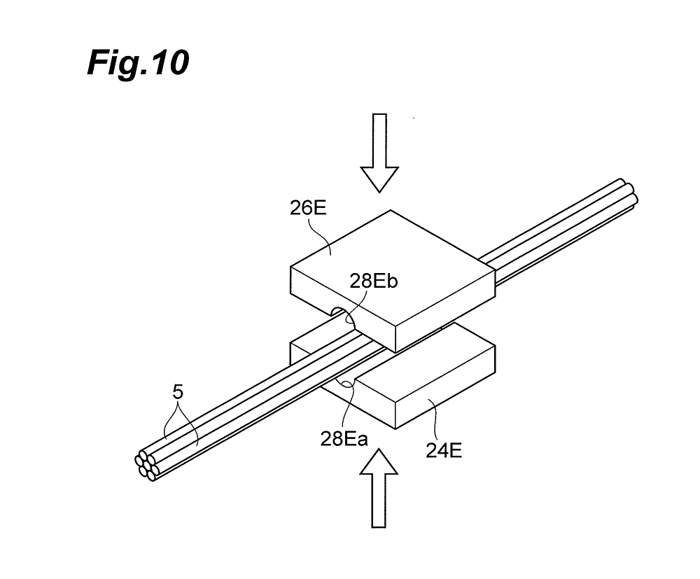

FIG. 11 is a perspective view illustrating a multicore fiber and single-core fibers connected together by the optical fiber connecting method in accordance with a second embodiment;

FIG. 12(a) is a view of a ferrule as seen from the front side, while FIG. 12(b) is a view of a state where the ferrule is attached to a housing as seen from the front side;

FIG. 13 is a view for explaining a method of attaching single-core fibers to a ferrule; and

FIG. 14 is a view illustrating inner structures of the ferrule.

### DESCRIPTION OF THE PREFERRED EMBODIMENTS

In the following, preferred embodiments of the present invention will be explained in detail with reference to the accompanying drawings. In the explanation of the drawings, the same or equivalent constituents will be referred to with the same signs, while omitting their overlapping descriptions.

### First Embodiment

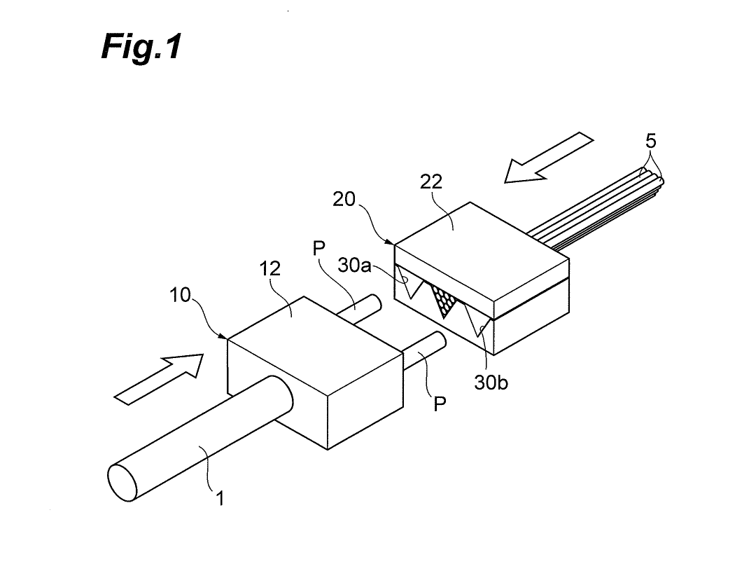

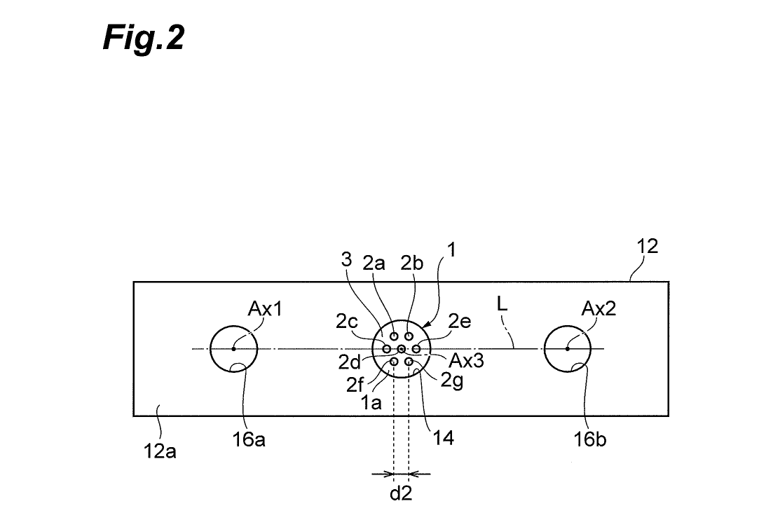

FIG. 1 is a perspective view illustrating a multicore fiber and single-core fibers connected together by the optical fiber connecting method in accordance with the first embodiment. FIG. 2 is a view of an MT ferrule as seen from an end face side of a multicore fiber.

As illustrated in FIG. 1, a multicore fiber (hereinafter referred to as MCF) 1 is connected to single-core fibers (hereinafter referred to as SCFs) 5 through MT connectors 10, 20. An optical fiber connecting structure is constructed by connecting the MT connectors 10, 20 to each other.

First, the MCF 1 and SCF 5 will be explained. As illustrated in FIG. 2, the MCF 1 is constituted by a plurality of (7 here) cores 2a to 2g each extending along a predetermined axis and a cladding integrally surrounding the plurality of cores 2a to 2g. The plurality of cores 2a to 2g are axially symmetrically arranged at equally-spaced intervals in a cross-section of the MCF 1. That is, 7 cores 2a to 2g in total constituted by 1 at the center position of the cladding 7 and 6 thereabout at intervals of 60° are arranged at equally-spaced intervals in the MCF 1.

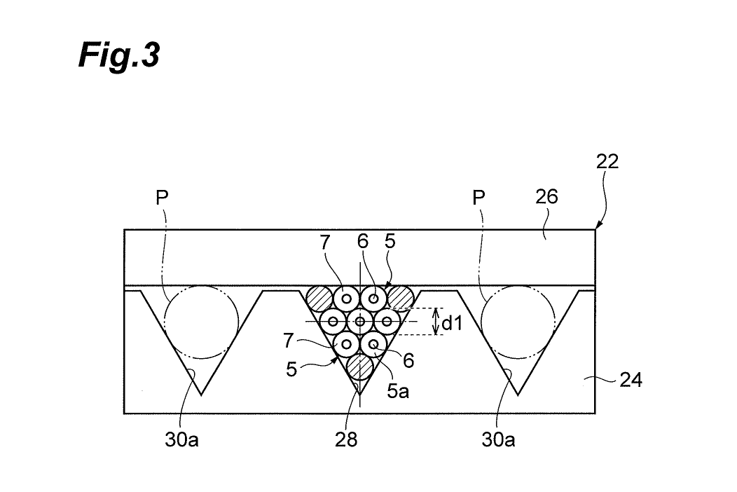

FIG. 3 is a view of an MT ferrule as seen from the front side. As illustrated in FIG. 3, each SCF 5 is constituted by a single core 6 extending along a predetermined axis and a cladding 7 surrounding the core 6. The SCF 5 is a fiber in which the cladding 7 has an outer diameter d1 equal to a distance d2 between the plurality of cores 2a to 2g in the MCF 1 (the distance between the center axes of the cores 2a to 2g), so that the outer diameter of the cladding 7 is thinned. The core 6 has the same diameter as with each of the cores 2a to 2g. The outer diameter of the cladding 7 in the SCF 5 may be thinned only at the leading end part thereof or throughout its length.

Returning to FIG. 1, the MT connector 10 has an MT ferrule (first connection member) 12. The MT ferrule 12 is formed with an MCF insertion hole (fiber insertion hole) 14 and two guide holes 16a, 16b.

The MCF insertion hole 14 is a through hole extending in a direction in which a front end face 12a of the MT ferrule 12 and a rear face thereof (not depicted) oppose each other. The MCF 1 is inserted into the MCF insertion hole 14 from the rear side of the MT connector 10. The MCF 1 is secured to the MCF insertion hole 14 with an adhesive, for example. An end face 1a of the MCF 1 and the front end face (connection end face) 12a of the MT ferrule 12 are substantially flush with each other. The diameter of the MCF insertion hole 14 is made substantially equal to or slightly greater than the outer diameter of the MCF 1.

The guide holes 16a, 16b are arranged such that the MCF insertion hole 14 is located therebetween. A line L connecting center axes Ax1, Ax2 of the two guide holes 16a, 16b to each other passes a center axis Ax3 of the MCF insertion hole 14. That is, the center axes Ax1, Ax2 of the two guide holes 16a, 16b are placed on the same line L1 as with the center axis Ax3 of the MCF insertion hole 14. Respective columnar guide pins P are inserted in the guide holes 16a, 16b so as to project from the front end face 12a of the MT ferrule 12.

As illustrated in FIG. 3, the MT connector 20 has an MT ferrule (second connection member) 22. The MT ferrule 22 is constituted by a first holding part (first part) 24 and a planar second holding part (second part) 26. The first and second holding parts 24, 26 are formed by silicon, glass, or resins, for example. The MT ferrule 22 keeps the SCFs 5 by holding them between the first and second holding parts 24, 26.

The first holding part 24 is formed with an SCF positioning groove (positioning part) 28 and guide grooves (guide parts) 30a, 30b. The SCF positioning groove 28 has a substantially V-shaped cross-section forming an angle of about 60°. A plurality of (10 here) SCFs 5 are arranged in ranks in the SCF positioning groove 28. With the second holding part 26, the SCF positioning groove 28 forms an SCF insertion hole for inserting the SCFs 5.

The guide grooves 30a, 30b are arranged such that the SCF positioning groove 28 is located therebetween. Each of the guide grooves 30a, 30b has a substantially V-shaped cross-section. With the second holding part 26, the guide grooves 30a, 30b define guide holes for inserting the guide pins P. The guide grooves 30a, 30b may have circular cross-sections in conformity to the (columnar) forms of the guide pins P.

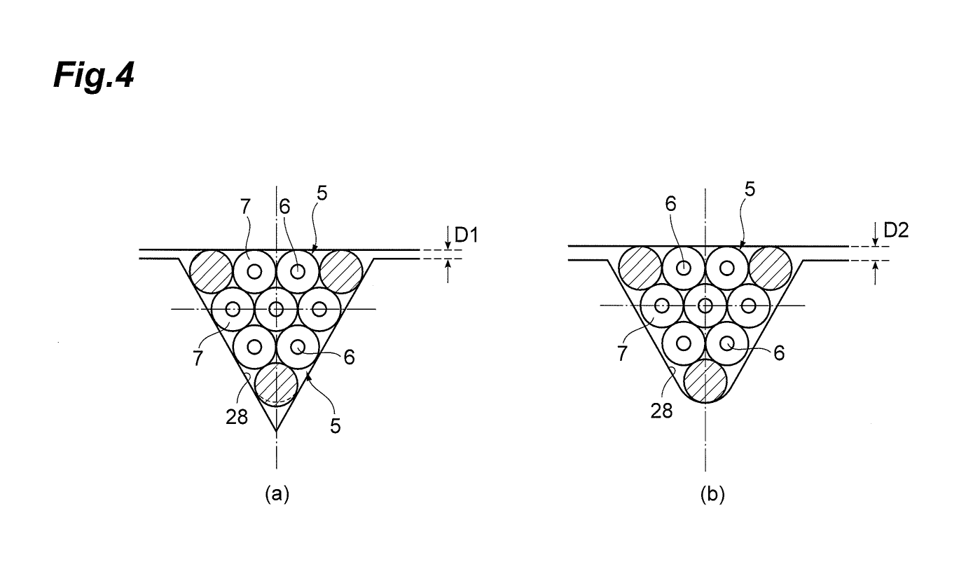

The SCF positioning groove 28 is formed by molding with glass or a resin, cutting of the first holding part 24 (substrate) with a V-shaped blade, etching of the first holding part 24 made of silicon, or the like. When the SCF positioning groove 28 is formed by molding or cutting with a blade, its bottom may become a curved surface as illustrated in FIG. 4(b). When the bottom has a curved form as such, the lowermost SCF 5 may interfere with the bottom and rise, thereby increasing the gap D2 between the first and second holding parts 24, 26. This may lower the accuracy in arranging the SCFs 5.

By contrast, as illustrated in FIG. 4(a), etching prevents the bottom from curving. This keeps the SCFs 5 from rising, whereby the gap D1 between the first and second holding parts 24, 26 can be made smaller (D1<D2). Therefore, the SCF positioning groove 28 is preferably formed by etching the first holding part 24 made of silicon.

A method of connecting the MCF 1 to a plurality of SCFs 5 will now be explained.

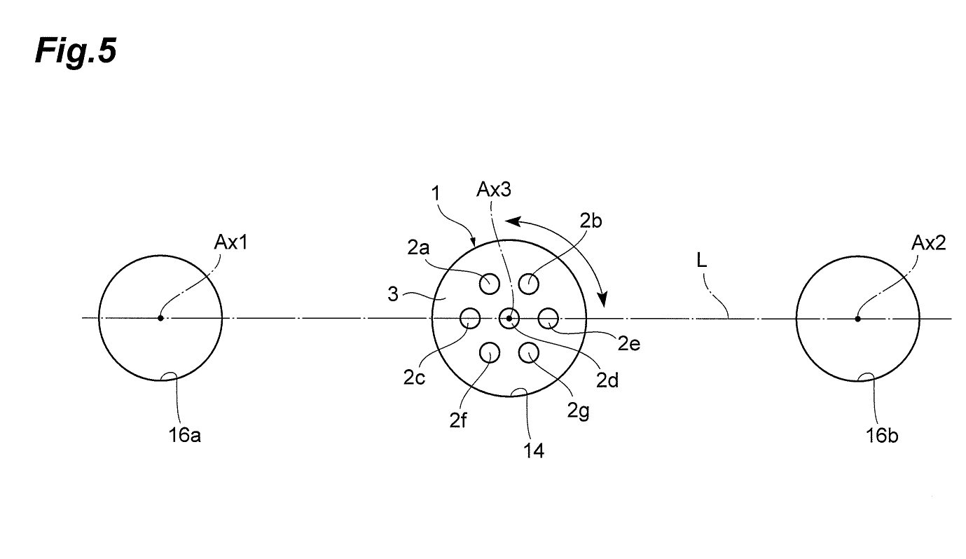

First, the MT ferrule 12 is prepared, and the MCF 1 is inserted into the MCF insertion hole 14 from the rear side of the MT ferrule 12. After being inserted 1 into the MCF insertion hole 14, the MCF 1 is axially rotated with respect to the MT ferrule 12 as illustrated in FIG. 5, so as to be positioned such that the arrangements of the cores 2a to 2g form a predetermined angle with the line L. Specifically, while the end face 1a of the MCF 1 is observed with a camera, for example, the MCF 1 is rotated and positioned so as to form a predetermined angle with the line L, i.e., the cores 2a to 2g are arranged at predetermined positions (first step). In this embodiment, the MCF 1 is rotated such that three cores 2c to 2e are located on the line L.

After being positioned, the MCF 1 is secured to the MT ferrule 12 with an adhesive. Then, the end face 1a of the MCF 1 is polished.

Subsequently, the MT ferrule 22 is prepared, and the SCFs 5 are arranged in the positioning groove 28. Specifically, as illustrated in FIG. 3, 10 SCFs 5 are inserted together into the positional groove 28, so as to be positioned. Among the 10 SCFs 5, 7 in total constituted by the center SCF 5 and the SCFs 5 arranged thereabout are fibers to be optically connected, while 3 not in contact with the center SCF 5 are dummy fibers (hatched in the drawings). After being positioned, the SCFs 5 are secured to the MT ferrule 22 with an adhesive (second step). Then, an end face 5a of each SCF 5 is polished.

Next, the MT ferrules 12, 22 are caused to oppose each other, and the guide pins P inserted in the guide holes 16a, 16b of the MT ferrule 12 are introduced into the guide holes 30a, 30b of the MT ferrule 22, respectively. Subsequently, the end face 1a of the MCF 1 and the end face 5a of the SCF 5 are caused to oppose each other, so that the MCF 1 is optically connected to a plurality of SCFs 5 (third step).

In this embodiment, as explained in the foregoing, the MCF 1 is connected to the plurality of SCFs 5 through the MT connectors 10, 20. The MCF 1 is axially rotated so as to be positioned with respect to the MT ferrule 12 and then is secured thereto. The plurality of SCFs 5 are positioned by the positioning groove 28 of the MT ferrule 22 so as to arrange the cores 6 at the respective positions corresponding to the arrangements of the cores 2a to 2g in the MCF 1 and then are fixed to the MT ferrule 22. Subsequently, the MT connectors 10, 20 are joined to each other, so as to connect the MCF 1 to the plurality of SCFs 5. The MCF 1 and SCFs 5 are thus positioned and connected, so that their cores 2a to 2g, 6 can be butted against each other with high accuracy, whereby the loss can be reduced. As a result, the MCF 1 can be connected to the SCFs 5 efficiently.

Since the positional groove 28 has a V-shaped cross-section, this embodiment can arrange a plurality of SCFs 5 in the positioning groove 28 and thus can favorably position the SCFs 5.

### Other Modes of MT Ferrule

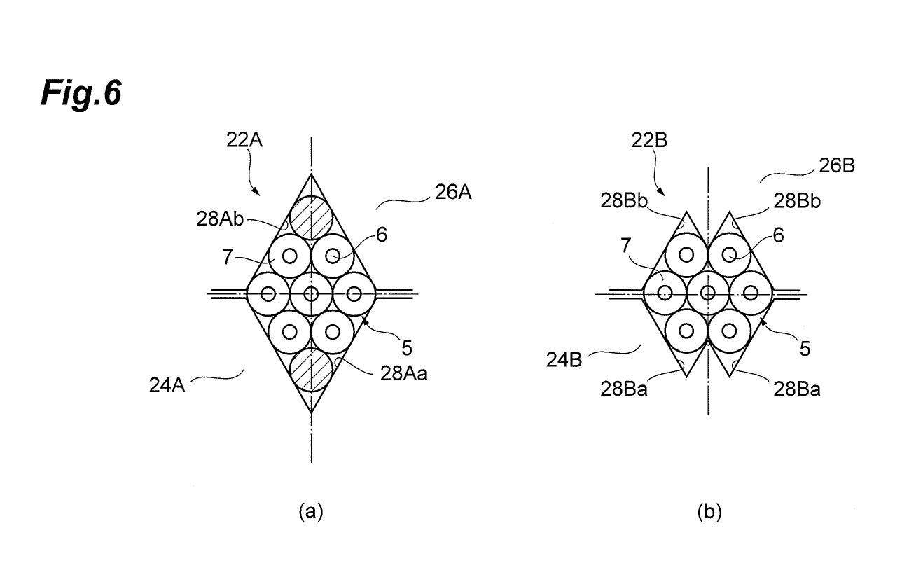

Other modes of the MT ferrule 22 will now be explained with reference to FIGS. 6 to 9. FIGS. 6 to 9 are views illustrating other modes of the MT ferrule.

As illustrated in FIG. 6(a), the MT ferrule 22A has first and second holding parts 24A, 26A formed with positioning grooves (first and second positioning parts) 28Aa, 28Ab. The positioning grooves 28Aa, 28Ab, each having a substantially V-shaped cross-section, are arranged so as to oppose each other. A plurality of (9 here) SCFs 5 are inserted into a fiber insertion hole defined by the positioning grooves 28Aa, 28Ab. Among the 9 SCFs 5, 7 SCFs are connected to the cores 2a to 2g of the MCF 1, respectively, while 2 SCFs 5 at the depicted uppermost and lowermost positions are dummy fibers (hatched in the drawing).

As illustrated in FIG. 6(b), an MT ferrule 22B has first and second holding parts 24B, 26B formed with positioning grooves 28Ba, 28Bb. The positioning grooves 28Ba, 28Bb, each having a substantially V-shaped cross-section, are formed 2 by 2 in the first and second holding parts 24B, 26B. No dummy fibers are necessary in thus constructed positioning grooves 28Ba, 28Bb.

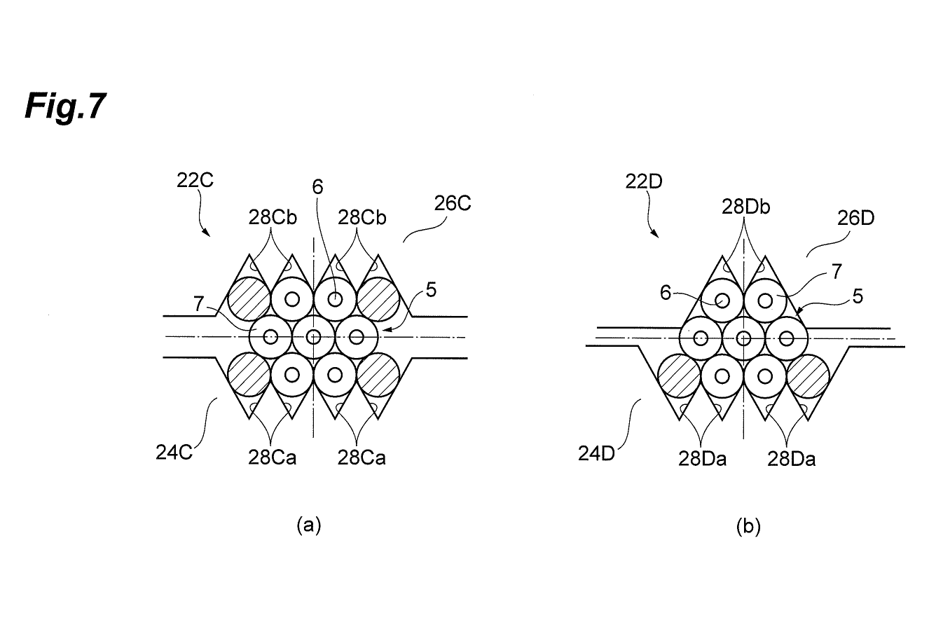

As illustrated in FIG. 7(a), an MT ferrule 22C has first and second holding parts 24C, 26C formed with positioning grooves 28Ca, 28Cb. The positioning grooves 28Ca, 28Cb, each having a substantially V-shaped cross-section, are formed 4 by 4 in the first and second holding parts 24C, 26C. Among 11 SCFs 5, 7 SCFs are connected to the cores 2a to 2g of the MCF 1, respectively, while 4 SCFs located at depicted 4 corners, respectively, are dummy fibers (hatched in the drawing).

As illustrated in FIG. 7(b), an MT ferrule 22D has first and second holding parts 24D, 26D formed with positioning grooves 28Da, 28Db. Each of the positioning grooves 28Da, 28Db has a substantially V-shaped cross-section. The first holding part 24D is formed with 2 positioning grooves 28Da, while the second holding part 26D is formed with 4 positioning grooves 28Db. Among 9 SCFs 5, 7 SCFs are connected to the cores 2a to 2g of the MCF 1, respectively, while 2 SCFs 5 located at the depicted lower leftmost and rightmost positions, respectively, are dummy fibers (hatched in the drawing).

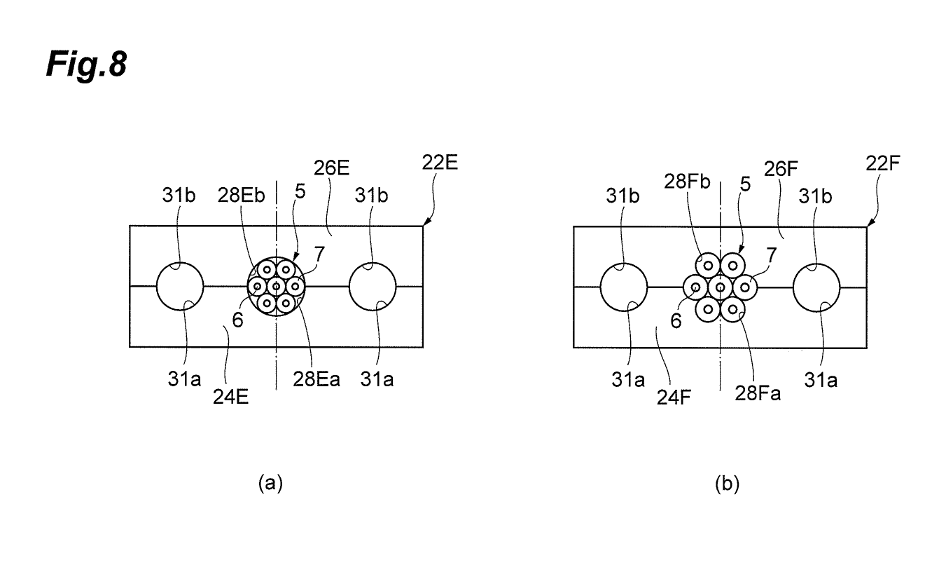

As illustrated in FIG. 8(a), an MT ferrule 22E has first and second holding parts 24E, 26E formed with positioning grooves 28Ea, 28Eb and guide grooves (first guide groove and second guide part) 31a, 31b. The positioning grooves 28Ea, 28Eb, each having a semicircular cross-section, are arranged so as to oppose each other. A plurality of (7 here) SCFs 5 are inserted into a space defined by the positioning grooves 28Ea, 28Eb. The guide grooves 31a, 31b, each having a semicircular cross-section, are arranged so as to oppose each other. When attaching the SCFs 5 to the MT ferrule 22E, the SCFs 5 are arranged into a predetermined form (hexagonal form) and then held by the first and second holding parts 24E, 26E and secured with an adhesive. A plurality of (7 here) SCFs 5 are inserted into a space defined by the positioning grooves 28Ea, 28Eb.

As illustrated in FIG. 8(b), an MT ferrule 22F has first and second holding parts 24F, 26F formed with positioning grooves 28Fa, 28Fb and guide grooves 31a, 31b. The positioning grooves 28Fa, 28Fb have cross-sectional forms corresponding to the outer form of a bundle of SCFs 5 (outer form of SCFs 5 arranged in a hexagonal form) and are arranged so as to oppose each other. A plurality of (7 here) SCFs 5 are inserted into a space defined by the positioning grooves 28Fa, 28Fb.

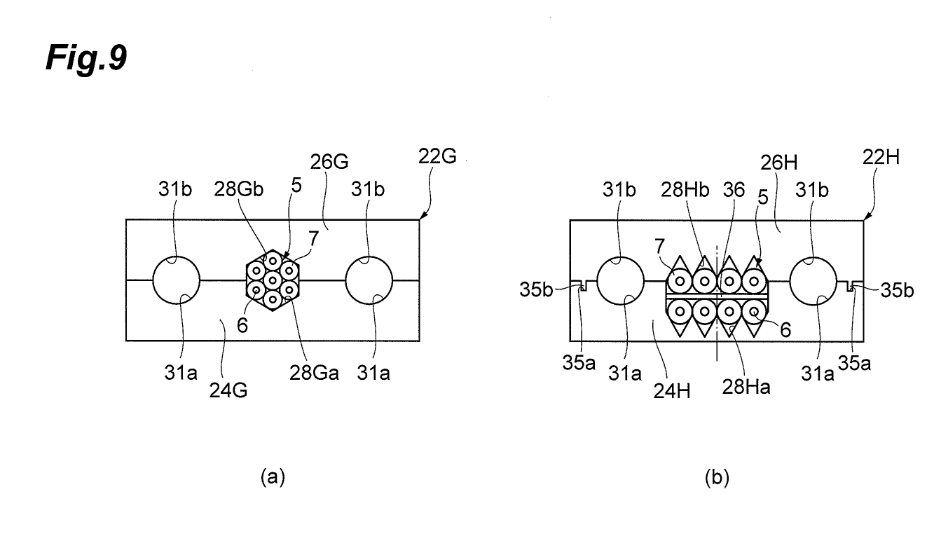

As illustrated in FIG. 9(a), an MT ferrule 22G has first and second holding parts 24G, 26G formed with positioning grooves 28Ga, 28Gb and guide grooves 31a, 31b. The positioning grooves 28Ga, 28Gb are arranged so as to oppose each other, while constituting a hexagonal cross-section. A plurality of (7 here) SCFs 5 are inserted into a space defined by the positioning grooves 28Ga, 28Gb.

As illustrated in FIG. 9(b), an MT ferrule 22H has first and second holding parts 24H, 26H formed with positioning grooves 28Ha, 28Hb and guide grooves 31a, 31b. The positioning grooves 28Ha, 28Hb, each having a rectangular cross-section, are arranged so as to oppose each other. Each of the positioning grooves 28Ha, 28Hb is formed with positioning indentations, each having a chevron cross-section, corresponding to respective SCFs 5. A plurality of (8 here) SCFs 5 are inserted into a space defined by the positioning grooves 28Ha, 28Hb. An insert member 36 is arranged between the upper and lower rows of 4 SCFs 5 each. The first holding part 24H is provided with depressions 35a, while the second holding part 26H is provided with projections 35b at positions corresponding to the depressions 35a. This positions the second holding part 26H with respect to the first holding part 24H.

In thus constructed MT ferrule 22H, the SCFs 5 are juxtaposed with each other at intervals of about 47 μm, for example, in the depicted horizontal line in each of the first and second holding parts and arranged with a gap of about 90 μm, for example, therebetween in the depicted vertical direction. That is, the SCF 5 are not arranged at equally-spaced intervals in the MT ferrule 22H. Therefore, a plurality of cores are not arranged at equally-spaced intervals in a cross-section of the MCF held by the MT ferrule 12 joined to the MT ferrule 22H. Thus, a plurality of cores may be arranged at equally-spaced intervals or not in a cross-section of the MCF 1 in this embodiment.

### Second Embodiment

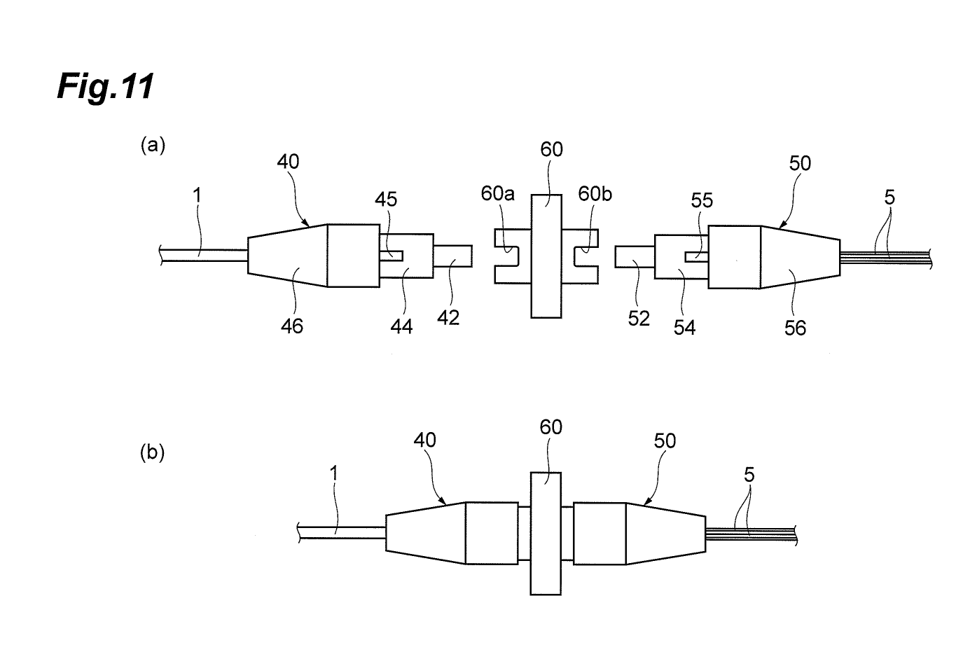

The second embodiment will now be explained. FIG. 11 is a view illustrating a multicore fiber and a single-core fiber which are connected by an optical fiber connecting method in accordance with the second embodiment. FIG. 11(a) illustrates a state before FC connectors 40, 50 are joined to an FC adapter 60, while FIG. 11(b) is a view illustrating a state where the FC connectors 40, 50 are joined to the FC adapter 60.

As illustrated in FIG. 11, the MCF 1 is connected to the SCFs 5 through the FC connectors 40, 50 and FC adapter 60. The FC connector 40 comprises a cylindrical ferrule 42 for holding the MCF 1, a first housing (accommodation member) 44 for accommodating the ferrule 42, and a second housing 46 disposed on the rear end side of the first housing 44.

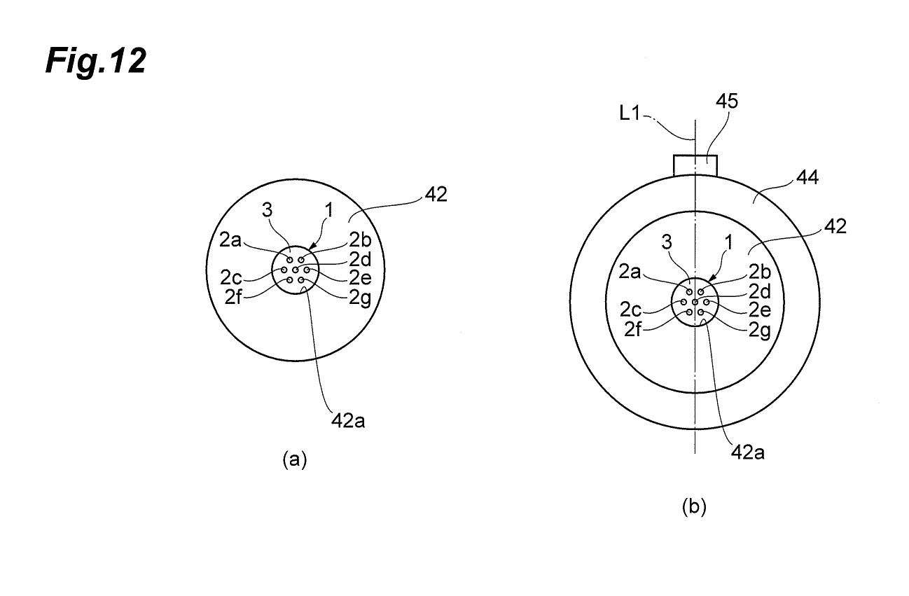

FIG. 12(a) is a view of the ferrule as seen from the front side, while FIG. 12(b) is a view of a state where the ferrule is attached to a housing as seen from the front side. As illustrated in FIG. 12, the ferrule 42 has an MCF insertion hole 42a for inserting the MCF 1. The MCF insertion hole 42a is disposed at substantially the center of the ferrule 42 and has a diameter slightly larger than the outer diameter of the MCF 1 so as to insert the latter therein.

As illustrated in FIGS. 11 and 12(b), the housing 44 is provided with a protrusion 45 to be inserted into a guide groove 60a of the FC adapter 60. The projection 45 projects radially of the housing 44, i.e., radially out of the ferrule 42. The projection 45 positions the FC connector 40 in the FC adapter 60.

The projection 45 is also used as a reference for positioning arrangements of cores 2a to 2g of the MCF 1. That is, when being positioned, the MCF 1 is rotated with respect to the ferrule 42 such that the arrangements of the cores 2a to 2g in the MCF 1 form a predetermined angle with a line L1 connecting the projection (predetermined position) 45 and the center axis of the MCF insertion hole 42a in the state where the ferrule 42 is accommodated in the housing 44 as illustrated in FIG. 12(b).

The FC connector 50 comprises a cylindrical ferrule 52 for holding the SCFs 5, a first housing 54 for accommodating the ferrule 52, and a second housing 56 disposed on the rear end side of the second housing 54.

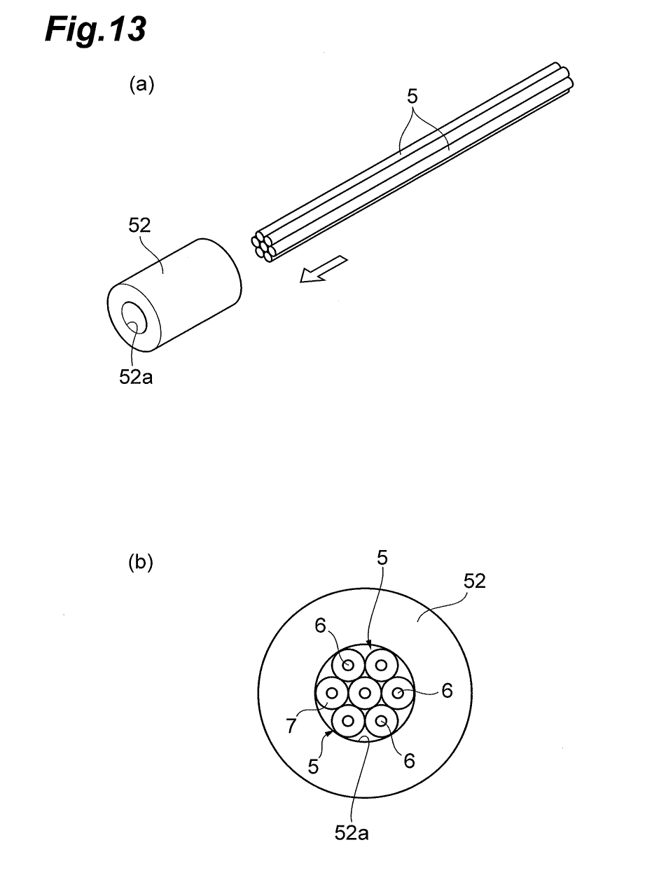

As illustrated in FIG. 13, the SCFs 5 are inserted in an SCF insertion hole 52a of the ferrule 52. The inner diameter of the SCF insertion hole 52a equals the outer size of a bundle of the SCFs 5, i.e., three times the outer diameter of the SCF 5.

A method of connecting the MCF 1 to a plurality of SCFs 5 will now be explained.

First, the ferrule 42 is prepared, and the MCF 1 is inserted into the ferrule insertion hole 42a from the rear side of the ferrule 42. After being inserted 1 into the MCF insertion hole 42a, the MCF 1 is axially rotated with respect to the ferrule 42 as illustrated in FIG. 12(b), so as to be positioned such that the arrangements of the cores 2a to 2g form a predetermined angle with the line L1. Specifically, while the end face 1a of the MCF 1 is observed with a camera, for example, the MCF 1 is rotated and positioned such that the MCF 1 forms a predetermined angle with the line L, i.e., the cores 2a to 2g are arranged at predetermined positions (first step).

After being positioned, the MCF 1 is secured to the ferrule 42 with an adhesive. Then, the end face la of the MCF 1 is polished.

Subsequently, the ferrule 52 is prepared, and the SCFs 5 are inserted into the SCF insertion hole 52a. Specifically, as illustrated in FIG. 13(a), 7 SCFs 5 are inserted together into the SCF insertion hole 52a from the rear side of the ferrule 52, so as to be positioned. Here, the SCFs 5 are provided with an axial tension (i.e., pulled axially). After being positioned, the SCFs 5 are secured to the ferrule 52 with an adhesive (second step). Then, an end face 5a of each SCF 5 is polished.

Next, the ferrules 42, 52 are caused to oppose each other, and the projections 45, 55 of the housings 44, 54 are inserted into the guide grooves 60a, 60b of the FC adapter 60, respectively. Subsequently, the end face 1a of the MCF 1 and the end face 5a of the SCF 5 are caused to oppose each other, so that the MCF 1 is optically connected to a plurality of SCFs 5 (third step).

In this embodiment, as explained in the foregoing, the MCF 1 is connected to the plurality of SCFs 5 through the FC connectors 40, 50. The MCF 1 is axially so as to be positioned with respect to the ferrule 42 and then is connected thereto. The plurality of SCFs 5 are positioned in the ferrule 52 so as to arrange the cores 6 at the respective positions corresponding to the arrangements of the cores 2a to 2g in the MCF 1 and then are fixed to the ferrule 52. Subsequently, the FC connectors 40, 50 are joined to each other through the FC adapter 60, so as to connect the MCF 1 to the plurality of SCFs 5. The MCF 1 and SCFs 5 are thus positioned and connected, so that their cores 2a to 2g, 6 can be butted against each other with high accuracy, whereby the loss can be reduced. As a result, the MCF 1 can be connected to the SCFs 5 efficiently.

Since the MCF 1 is positioned by using the projection 45 provided with the housing 44, the arrangements of the cores 2a to 2g can attain a predetermined angle easily and accurately in this embodiment. Therefore, the MCF 1 can be positioned easily and reliably.

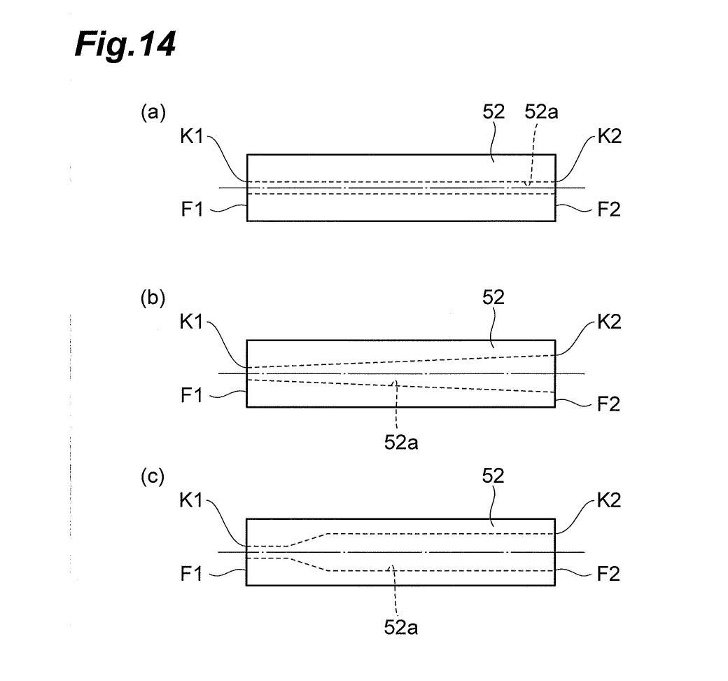

The present invention is not limited to the above-mentioned embodiments. For example, the ferrule 52 may be configured as follows in the second embodiment. FIG. 14 is a view illustrating inner structures of the ferrule. As illustrated in FIG. 14(a), the ferrule 52 may have the same inner diameter (bore) at an opening K1 on the front end face F1 side and an opening K2 on the rear end face F2 side, i.e., the SCF insertion hole 52a may have a fixed inner diameter throughout its length. As illustrated in FIGS. 14(b) and 14(c), the ferrule 52 may be formed such that the opening K2 on the rear end face F2 side has an inner diameter greater than that of the opening K1 on the front end face F1 side, i.e., the SCF insertion hole 52a is tapered. Such a structure reduces the friction at the time of inserting the SCFs 5, so that the latter can be inserted easily and reliably.

While the second embodiment positions the SCFs 5 by inserting them into the SCF insertion hole 52a in the ferrule 52, the SCFs 5 may be positioned by using a ferrule formed with a positioning groove as in the ferrule illustrated in the first embodiment.

While the second embodiment provides the housing 44 with the projection 45, by which the FC connector 40 is positioned in the FC adapter 60, other structures (such as depressions and orientation flats) may be used for positioning the FC connector 40 in the FC adapter 60. Though the projection 45 is also used as a predetermined position for a reference for positioning the arrangements of the cores 2a to 2g in the MCF 1, forms other than the projection 45 may also be used as the reference for positioning.

What is claimed is:

1. An optical fiber connecting method for connecting a multicore fiber, constituted by a plurality of cores and a cladding integrally surrounding the plurality of cores, to a single-core fiber constituted by a single core and a cladding surrounding the core;
the method comprising:
a first step of preparing a first connection member for holding the multicore fiber, positioning the multicore fiber in the first connection member, and then fixing the multicore fiber to the first connection member;
a second step of preparing a second connection member for holding a plurality of single-core fibers, positioning the single-core fibers such that the single cores are arranged at respective positions corresponding to arrangements of the plurality of cores in the multicore fiber, and then fixing the plurality of single-core fibers to the second connection member; and
a third step of positioning and joining the first and second connection members such that the plurality of cores face the respective single cores, so as to connect the multicore fiber to the plurality of single-core fibers.

2. An optical fiber connecting method according to claim 1, wherein the multicore fiber has the plurality of cores arranged at equally-spaced intervals in a cross-section thereof; and
wherein the single core fiber is configured such that at least a leading end part of the cladding has an outer diameter equal to an interval between the plurality of cores.

3. An optical fiber connecting method according to claim 1, wherein the first connection member has:
a fiber insertion hole for inserting the multicore fiber, and
a guide hole for inserting a guide pin;
wherein the second connection member has:
a positioning part for defining the arrangements of the single-core fibers so as to place the single cores in the single-core fibers at positions corresponding to the arrangements of the plurality of cores in the multicore fiber, and
a guide part for inserting the guide pin; and
wherein the guide pin joins the first and second connection members to each other in the third step.

4. An optical fiber connecting method according to claim 3, wherein the plurality of cores are arranged axially symmetrically at equally-spaced intervals in a cross-section thereof;
wherein the first connection member is provided with at least two guide holes, the two guide holes being arranged such that the fiber insertion hole is located therebetween; and
wherein the first step axially rotates and positions the multicore fiber with respect to the first connection member such that the arrangements of the plurality of cores form a predetermined angle with a line connecting respective center axes of the two guide holes.

5. An optical fiber connecting method according to claim 3, wherein the second connection member is provided with at least two guide parts, the two guide parts being arranged such that the positioning part is located therebetween; and
wherein the second step arranges the single-core fibers at the positioning part, so as to position the plurality of single-core fibers.

6. An optical fiber connecting method according to claim 5, wherein the second connection member comprises:
a first part formed with the positioning part and guide part, and
a second part for holding the plurality of single-core fibers with the first part.

7. An optical fiber connecting method according to claim 5, wherein the second connection member comprises:
a first part formed with a first positioning part constituting the positioning part and a first guide part constituting the two guide parts, and
a second part formed with a second positioning part constituting the positioning part while being arranged so as to oppose the first positioning part and a second guide part constituting the two guide parts while being arranged so as to oppose the first guide part; and
wherein the single-core fiber is held by the first and second parts.

8. An optical fiber connecting method according to claim 5, wherein the positioning part has a substantially V-shaped cross-section.

9. An optical fiber connecting method according to claim 5, wherein the positioning part has a cross-section exhibiting a form corresponding to an outer form of a bundle of the plurality of single-core fibers.

10. An optical fiber connecting method according to claim 1, wherein the first connection member comprises:
a cylindrical ferrule having a fiber insertion hole for inserting the multicore fiber, and
an accommodation member for accommodating the ferrule; and
wherein the first step axially rotates and positions the multicore fiber such that the arrangements of the plurality of cores form a predetermined angle with a line connecting a predetermined position of the accommodation member and a center axis of the fiber insertion hole.

11. An optical fiber connecting method according to claim 10, wherein the plurality of cores are arranged axially symmetrically at equally-spaced intervals;
wherein the accommodation member is provided with a projection projecting radially out of the ferrule; and
wherein the first step axially rotates and positions the multicore fiber such that the arrangements of the plurality of cores form a predetermined angle with a line connecting the projection and the center axis of the fiber insertion hole.

12. An optical fiber connecting method according to claim 10, wherein the second connection member has a positioning part for defining the arrangements of the single-core fibers so as to place the single cores in the single-core fibers at positions corresponding to the arrangements of the plurality of cores in the multicore fiber; and
wherein the second step arranges the single-core fibers at the positioning part, so as to position the plurality of single-core fibers.

13. An optical fiber connecting method according to claim 12, wherein the positioning part has a substantially V-shaped cross-section.

14. An optical fiber connecting method according to claim 12, wherein the positioning part has a cross-section exhibiting a form corresponding to an outer form of a bundle of the plurality of single-core fibers.

15. An optical fiber connecting method according to claim 10, wherein the second connection member comprises a cylindrical ferrule including a fiber insertion hole, having an inner diameter substantially equal to an outer size of the plurality of single-core fibers, for inserting the plurality of single-core fibers; and
wherein the second step inserts and positions the plurality of single-core fibers in the fiber insertion hole.

16. An optical fiber connecting method according to claim 15, wherein the fiber insertion hole of the ferrule has a greater bore on one end side for inserting the plurality of single-core fibers therefrom than on the other end side.

17. An optical fiber connecting structure connecting a multicore fiber, constituted by a plurality of cores and a cladding integrally surrounding the plurality of cores, to a single-core fiber constituted by a single core and a cladding surrounding the core;
the optical fiber connecting structure comprising:
a first connection member for holding the multicore fiber, and
a second connection member for holding a plurality of single-core fibers;
wherein the first connection member positions and fixes the multicore fiber;
wherein the second connection member arranges the single cores at respective positions corresponding to arrangements of the plurality of cores in the multicore fiber and fixes the plurality of single-core fibers; and
wherein the first and second connection members are positioned and joined to each other such that the plurality of cores face the respective single cores.

18. An optical fiber connecting structure according to claim 17, wherein the multicore fiber has the plurality of cores arranged at equally-spaced intervals in a cross-section thereof; and
wherein the single core fiber is configured such that at least a leading end part of the cladding has an outer diameter equal to an interval between the plurality of cores.

19. An optical fiber connecting structure according to claim 17, wherein the first connection member has:
a fiber insertion hole for inserting the multicore fiber, and
a guide hole for inserting a guide pin;
wherein the second connection member has:
a positioning part for defining the arrangements of the single-core fibers so as to place the single cores in the single-core fibers at positions corresponding to the arrangements of the plurality of cores in the multicore fiber, and
a guide part for inserting the guide pin; and
wherein the guide pin joins the first and second connection members to each other.

20. An optical fiber connecting structure according to claim 19, wherein the second connection member comprises:
a first part formed with the positioning part and guide part, and
a second part for holding the plurality of core fibers with the first part.

21. An optical fiber connecting structure according to claim 19, wherein the second connection member comprises:
a first part formed with a first positioning part constituting the positioning part and a first guide part constituting two guide parts, and
a second part formed with a second positioning part constituting the positioning part while being arranged so as to oppose the first positioning part and a second guide part constituting the two guide parts while being arranged so as to oppose the first guide part; and
wherein the single-core fiber is held by the first and second parts.

22. An optical fiber connecting structure according to claim 19, wherein the positioning part has a substantially V-shaped cross-section.

23. An optical fiber connecting structure according to claim 19, wherein the positioning part has a cross-section exhibiting a form corresponding to an outer form of a bundle of the plurality of single-core fibers.

24. An optical fiber connecting structure according to claim 17, wherein the first connection member comprises:
a cylindrical ferrule having a fiber insertion hole for inserting the multicore fiber, and
an accommodation member for accommodating the ferrule.

25. An optical fiber connecting structure according to claim 24, wherein the second connection member has a positioning part for defining the arrangements of the single-core fibers so as to place the single cores in the single-core fibers at positions corresponding to the arrangements of the plurality of cores in the multicore fiber.

26. An optical fiber connecting structure according to claim 25, wherein the positioning part has a substantially V-shaped cross-section.

27. An optical fiber connecting structure according to claim 25, wherein the positioning part has a cross-section exhibiting a form corresponding to an outer form of a bundle of the plurality of single-core fibers.

28. An optical fiber connecting structure according to claim 24, wherein the second connection member comprises a cylindrical ferrule including a fiber insertion hole, having an inner diameter substantially equal to an outer size of the plurality of single-core fibers, for inserting the plurality of single-core fibers.

29. An optical fiber connecting structure according to claim 28, wherein the fiber insertion hole of the ferrule has a greater bore on one end side for inserting the plurality of single-core fibers therefrom than on the other end side.
